(19) United States
(12) Patent Application Publication
(10) Pub. No.: US 2025/0259423 A1
(43) Pub. Date: Aug. 14, 2025

(54) MODEL IMAGE GENERATION USING RECAPTIONED IMAGES

(71) Applicant: OpenAI Opco, LLC, San Francisco, CA (US)

(72) Inventors: Aditya RAMESH, San Francisco, CA (US); James BETKER, Boulder, CO (US)

(73) Assignee: OpenAI Opco, LLC, San Francisco, CA (US)

(21) Appl. No.: 19/054,322

(22) Filed: Feb. 14, 2025

Related U.S. Application Data
(60) Provisional application No. 63/553,496, filed on Feb. 14, 2024.

(51) Int. Cl. G06V 10/774; G06F 40/40; G06T 11/00; G06V 20/70

(52) U.S. Cl. CPC G06V 10/774; G06F 40/40; G06T 11/00; G06V 20/70

(57) ABSTRACT

Disclosed herein are methods, systems, and computer-readable media for generating image captions for training a machine learning model. Current image generation models are hindered by the prevalence of improper or inaccurate captions, which leads to suboptimal training data. This results in less effective image generation models. Disclosed systems and methods involve obtaining a text-to-image dataset including one or more digital image-caption pairs. Systems and methods involve generating a recaptioned dataset by applying an image captioner model to images in the text-to-image dataset. An image captioner model can be trained with an improved image dataset, a first tuning stage, and a second tuning stage, for improved performance.

### CROSS-REFERENCE TO RELATED APPLICATIONS

This application claims priority under 35 U.S.C. § 119 to U.S. Provisional Application No. 63/553,496, filed on Feb. 14, 2024. The disclosures of the above-referenced application are expressly incorporated herein by reference in its entirety.

### FIELD OF DISCLOSURE

The disclosed systems, devices, methods, and computer readable media generally relate to improving machine learning model image generation using recaptioned images. Disclosed systems, methods, and computer-readable media may relate to datasets for training machine learning models.

### BACKGROUND

Language models and image generation models are examples of generative artificial intelligence (AI) and/or machine-learning (ML) models. Language models can be trained on text datasets to understand text input and generate text outputs. Image generation models can be trained to understand images and generate images (e.g., based on a text description). For example, some image generation models may, given a text prompt, generate an image corresponding to the prompt. Such image generation systems can be trained on datasets including images and corresponding captions.

Image generation models often utilize architectures such as Generative Adversarial Networks (GANs) or Variational Autoencoders (VAEs) to understand and produce images. GANs, for instance, consist of two neural networks—a generator and a discriminator—to create realistic images. The generator creates images, while the discriminator evaluates them, providing feedback to improve the generator's output. This iterative process enables the generation of increasingly realistic images. Additionally, the integration of attention mechanisms and transformer models has further enhanced the ability of image generation systems to understand and generate complex visual content based on textual descriptions.

### SUMMARY

The disclosed systems and methods are directed to improving image to text generation models using techniques that enable better performance. Depending on their training and operation, image generation models, such as text-to-image models, may generate images that are incoherent, low-quality, or inaccurate with respect to an input text description. For example, traditional models may not capture all details present in the text description, may ignore details, or may confuse words or instructions in the prompt.

Moreover, for such image generation systems trained on text-to-image datasets, such as datasets including images and corresponding captions, the data can often have poor quality. For example, datasets may include data from the internet (e.g., public images and corresponding captions). However, the captions in datasets may be of poor quality, as the captions may fail to describe the image, fail to provide enough details on the image, or may be irrelevant or only marginally related to the image. Data in traditional text-to-image datasets may be derived from humans, and the captions may omit relationships, text, colors, sizes, positions, numbers, or background details present in the image. Thus, for image generation models trained on such poor datasets, the generated images may be lacking in aesthetic quality and/or they may have poor accuracy with respect to the prompt.

Further, the text-to-image datasets may be large in nature, including large amounts of data such as many images and many captions. The datasets may require high computational power and consume large amounts of memory (e.g., for training). Addressing concerns of quality and accuracy with human input can be prohibitively costly and time-consuming. Further, while addressing such concerns with automation may save some time and introduce some efficiencies, traditional automation is too computationally expensive, requiring high amounts of processing and/or memory usage.

The disclosed systems and methods address these and other problems in the prior art by providing an image recaptioning system. The disclosed systems and methods include an image captioner model which may efficiently, autonomously, and accurately recaption images in a text-to-image dataset.

Improving image generation models involves training datasets that encompass large quantities of varied images paired with precise and detailed descriptions. Collecting, managing, and categorizing such datasets can be challenging. The disclosed systems and methods address this by leveraging language models to generate enhanced captions (e.g., transforming short captions into long, descriptive ones). This enhancement can improve the performance of image generators, making them more capable of generating high-quality images. For example, training with datasets generated with disclosed systems and methods can allow image generators to produce detailed and accurate images even from brief user prompts. The expansion of captions from short or nondescriptive to comprehensive descriptions can improve the training datasets and, consequently, the models trained on these datasets are able to better interpret user requests and generate visually rich images. With the disclosed systems and methods, image generation models can be trained so that users provide simple inputs and still receive high-quality, detailed images. Thus, image generators can be more user-friendly and efficient, as it reduces the need for users to provide lengthy and detailed prompts, or provide multiple prompts.

In particular, the disclosed systems and methods provide a practical benefit of improving image quality. Image generation models can be trained on datasets including image-caption pairs. However, traditional training of image generation models faces significant challenges due to poor quality captions, including the prevalence of improper or inaccurate captions in the training dataset. These captions often fail to accurately describe the content of the images, leading to suboptimal training data and, consequently, less effective image generation models. To address this issue, the disclosed systems and methods introduce an image recaptioning system that leverages language models to generate high-quality captions. This image captioner can be configured to autonomously review and recaption images in a text-to-image dataset, ensuring that the captions are both relevant and descriptive. By improving the quality of the captions, the image captioner can enhance the overall dataset, leading to better-trained and more accurate image generation models. As such, the image generation models can produce improved images that more faithfully follow a given prompt, resulting in a more accurate, more aesthetically pleasing image (e.g., for an end user).

The image captioner system can also incorporate technical features to enhance its functionality and integration with existing technologies. For example, the disclosed system and methods may be configured to operate and generate captions on compressed images to minimize transmission burden. Further, in some configurations, the image captioner can allow for real-time updates to the text-to-image dataset. Additionally, the image captioner can be configured to append classification information to digital image data, providing metadata that further refines the context and accuracy of the generated captions. This appended classification information can include details such as the main subject, background elements, colors, and themes. By incorporating these technical enhancements, the image captioner system not only improves the quality of the captions but also ensures seamless integration with various digital platforms and networks.

The image captioner model may be trained using the text-to-image dataset. The image captioner model may be trained on a subset of the text-to-image dataset. In some examples, the image captioner model may be tuned to improve performance of the image captioner model, thereby generating higher-quality captions. For example, the image captioner model may be tuned in a first tuning stage, which may involve updating the image captioner model using a first set of captions. The first set of captions may relate to the main subject of images.

In some examples, the image captioner model may generate a set of short synthetic captions. For example, the short synthetic captions may briefly describe the focus of an image. The image captioner model may also be tuned in a second tuning stage using a second set of captions. The second set of captions may relate to background details, colors, and themes in the image. In some examples, the image captioner model may generate a set of descriptive synthetic captions, which describe more details present in the image. Thus, tuning the image captioner model may guide the image captioner model to generate relevant, descriptive captions for images. The tuned image captioner model may be used to enhance the text-to-image dataset by recaptioning images in the text-to-image dataset, thereby updating captions in the text-to-image dataset with improved captions. As such, the text-to-image dataset may be improved, thereby improving training of image generation models trained on the dataset.

Some of the disclosed methods involve processes to enhance the training datasets for image generators (or machine learning models in general). The method can involve multiple steps such as initially collecting a text-to-image dataset that includes pairs of digital images and their captions. Then, a trained model functioning as an image captioner model can create a new, improved dataset by generating enhanced captions for the images. For example, the image captioner model can be trained using an image dataset and fine-tuned in multiple stages to ensure high-quality captions. In an initial stage the image captioner model can be tuned with a set of short captions that describe the main subject of the images and the updated image captioner model can be configured to generate synthetic captions for the image dataset. In the second stage, the image captioner model is further updated with a second set of captions that provide more detailed descriptions, including background elements, colors, and themes. The image captioner model can produce a set of descriptive synthetic captions that are longer and more detailed than the initial short captions, thereby enriching the dataset and improving the overall quality of the image generation model.

Some of the disclosed systems can improve captions for images. The system (which can be implemented with a computer system having processors and memories) can be configured to create the image captioner model. The training process can happen in two stages. In the first stage, the model can be trained with a set of captions that describe the main subjects of the images and the model generates a set of short, synthetic captions for the images. In the second stage, the model can be further trained with another set of captions that provide more detailed descriptions, including background elements and other specifics. This results in a set of longer, more descriptive synthetic captions. And the system can be configured to use the fine-tuned image captioner model to apply these improved captions to a new set of images, creating a high-quality, captioned dataset.

Other systems, methods, and computer-readable media are also discussed herein. Disclosed systems, methods, and computer-readable media may include any of the above aspects alone or in combination with one or more aspects, whether implemented as a method, by at least one processor, and/or stored as executable instructions on non-transitory computer readable media.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram illustrating an exemplary machine learning platform for implementing various aspects of this disclosure, consistent with systems and methods of the present disclosure.

FIG. 2 illustrates a flow diagram of a method for training a text-to-image machine learning model, consistent with systems and methods of the present disclosure.

FIG. 3 illustrates a block diagram of a system for recaptioning images, consistent with systems and methods of the present disclosure.

FIG. 4 illustrates a table of exemplary image captions, consistent with systems and methods of the present disclosure.

FIG. 5 illustrates a block diagram of a system for generating images with a recaptioned dataset, consistent with systems and methods of the present disclosure.

FIG. 6 illustrates a flow diagram of a method for generating image captions for training a machine learning model, consistent with systems and methods of the present disclosure.

FIG. 7 illustrates a flow diagram of a method for enhancing a training dataset, consistent with systems and methods of the present disclosure.

FIG. 8 illustrates an exemplary method for upsampling a text description, consistent with systems and methods of the present disclosure,

FIG. 9 is a block diagram illustrating an exemplary operating environment for implementing various aspects of this disclosure, consistent with systems and methods of the present disclosure.

### DETAILED DESCRIPTION

Exemplary systems, methods, and computer-readable media are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example systems, methods, and computer-readable media. However, it will be understood by those skilled in the art that the principles of the exemplary systems, methods, and computer-readable media may be practiced without every specific detail. Well-known methods, procedures, and components have not been described in detail so as not to obscure the principles of the example systems, methods, and computer-readable media. Unless explicitly stated, the example methods and processes described herein are neither constrained to a particular order or sequence nor constrained to a particular system configuration. Additionally, some of the described systems, methods, and computer-readable media or elements thereof can occur or be performed (e.g., executed) simultaneously, at the same point in time, or concurrently. Reference will now be made in detail to the disclosed systems, methods, and computer-readable media, examples of which are illustrated in the accompanying drawings.

It is to be understood that the descriptions herein are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

As described herein, image generation models may be trained on text-to-image datasets which, while having large amounts of data, often include low-quality captions that do not provide details on the images corresponding to the captions. Thus, image generation models trained on low-quality text-to-image datasets, the models may sometimes perform poorly, such as by generating images that may include errors or that are not aligned with a given prompt (e.g., producing an image which ignores instructions). Moreover, improving the text-to-image datasets with large language models or humans can be costly and/or time-consuming.

The disclosed systems and methods relate to improving text-to-image datasets through image captioner models. The disclosed systems and methods include tuning stages to refine the model such that the model generates accurate, relevant, and detailed captions. The disclosed systems and methods also involve recaptioning datasets by applying the model to images in text-to-image datasets to generate new or enhanced captions.

The disclosed systems and methods provide improvements to datasets for training machine learning models, including image generation models (e.g., text-to-image models). By generating improved captions for datasets, which include an image and a corresponding text description (e.g., a text-to-image dataset with image-caption pairs), image generation models can be trained on more robust, accurate training data. When an image generation model is trained on the higher quality training data the model will be able to generate better images, such as images with improved aesthetic quality (e.g., images with higher resolution, more quality, better texture), improved image semantics (e.g., images may present a more consistent style or theme), and more coherent images (e.g., images that may be easy to comprehend or involve objects that exist). For example, for models that generate images based on a prompt, such as a text description, improved model training may enable images that are more representational of the input prompt (e.g., more accurately match the given input or desired task) and more photorealistic. The disclosed systems and methods provide improved model training and improved text-to-image datasets for model training.

In particular, improving the image generation capabilities of machine learning models, including text-to-image models, can depend on the training of such models. The training of such models can be hindered by poor training data, such as low-quality text captions in a training dataset of image-caption pairs. Aspects of the present disclosure provide techniques for generating enhanced captions for training datasets (e.g., providing more alignment between images and corresponding captions), thereby improving the model training. For example, some systems and methods include an image captioner model that enhances captions for an image, such as by restructuring the caption for clarity or adding detail to the caption. Training image generation models on improved datasets can help models better understand and represent text-image correspondence, resulting in an increased ability to generate images that more accurately reflect an input prompt. For example, when an image generation model receives a prompt, the model can generate an image based on the prompt. In some examples, for the same caption or a caption of similar length or level of detail, models trained on enhanced datasets, as described herein, may generate better images than models trained with datasets having poor or poorer-quality captions. Thus, the disclosed systems and methods may provide improvements to image generation models and generated images, such as improvements in responsiveness to words, ordering of words, and meanings of phrases in prompts used in image generation with image generation models.

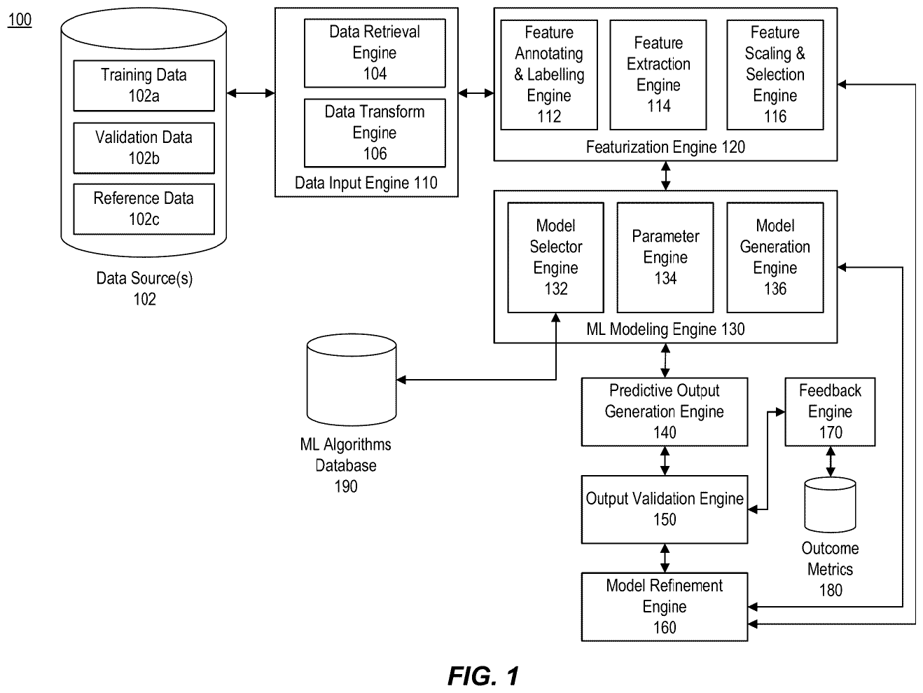

FIG. 1 is a block diagram illustrating an exemplary machine learning platform for implementing various aspects of this disclosure, according to some embodiments of the present disclosure.

System 100 may include data input engine 110 that can further include data retrieval engine 104 and data transform engine 106. Data retrieval engine 104 may be configured to access, interpret, request, or receive data, which may be adjusted, reformatted, or changed (e.g., to be interpretable by other engines, such as data input engine 110). For example, data retrieval engine 104 may request data from a remote source using an API. Data Input engine 110 may be configured to access, interpret, request, format, re-format, or receive input data from data source(s) 102. For example, data input engine 110 may be configured to use data transform engine 106 to execute a re-configuration or other change to data, such as a data dimension reduction.

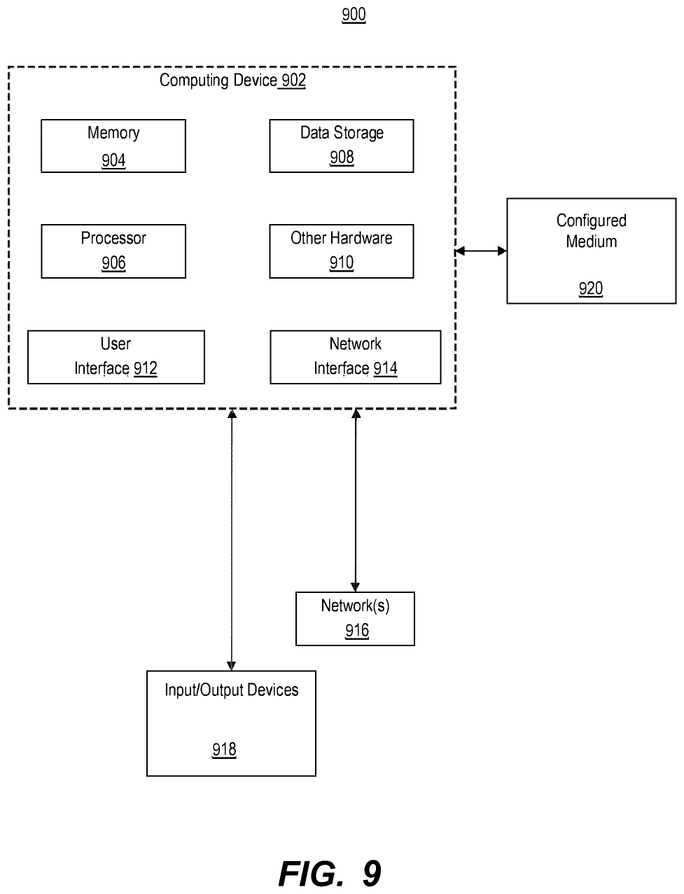

Data source(s) 102 may exist at one or more memories and/or data storages. In some disclosed systems, data source(s) 102 may be associated with a single entity (e.g., organization) or with multiple entities. Data source(s) 102 may include one or more of training data 102a (e.g., input data to feed a machine learning model as part of one or more training processes), validation data 102b (e.g., data with which at least one processor may compare model output, such as to determine model output quality), and/or reference data 102c (e.g., ground truth data or standardized data that can be used to contextualize model results). In some disclosed systems, data input engine 110 can be implemented using at least one computing device (e.g., computing device 902 in FIG. 9). For example, data from data sources 102 can be obtained through one or more I/O devices and/or network interfaces. Further, the data may be stored (e.g., during execution of one or more operations) in a suitable storage or system memory.

Data input engine 110 may also be configured to interact with data storage, which may be implemented on a computing device that stores data in storage or system memory. System 100 may also include machine learning (ML) modeling engine 130, which may be configured to execute one or more operations on a machine learning model (e.g., model training, model re-configuration, model validation, model testing), such as those described in the processes described herein. For example, ML modeling engine 130 may execute an operation to train a machine learning model, such as adding, removing, or modifying a model parameter. Training of a machine learning model may be supervised, semi-supervised, or unsupervised. In some disclosed systems, training of a machine learning model may include multiple epochs, or passes of data (e.g., training data 102a) through a machine learning model process (e.g., a training process). In some disclosed systems, different epochs may have different degrees of supervision (e.g., supervised, semi-supervised, or unsupervised). Data used to train a model may include input data (e.g., as described above) and/or data previously output from a model (e.g., recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed systems and methods in any way, a machine learning model may include millions, billions, trillions, or even more model parameters. System 100 may include featurization engine 120. Featurization engine 120 may include feature annotating & labeling engine 112 (e.g., configured to annotate or label features from a model or data, which may be extracted by feature extraction engine 114), feature extraction engine 114 (e.g., configured to extract one or more features from a model or data), and/or feature scaling and selection engine 116. Feature scaling and selection engine 116 may be configured to determine, select, limit, constrain, concatenate, or define features (e.g., AI features) for use with AI models. In some systems, featurization engine 120 can utilize storage or system memory for storing data and can utilize one or more I/O devices or network interfaces for transmitting or receiving data. ML modeling engine 130 may include model selector engine 132 (e.g., configured to select a model from among a plurality of models, such as based on input data), parameter selector engine 134 (e.g., configured to add, remove, and/or change one or more parameters of a model), and/or model generation engine 136 (e.g., configured to generate one or more machine learning models, such as according to model input data, model output data, comparison data, and/or validation data). ML algorithms database 190 (or other data storage) may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein.

System 100 can further include predictive output generation engine 140 (e.g., configured to generate outputs with models from modeling engine 130), output validation engine 150 (e.g., configured to apply validation data to machine learning model output), feedback engine 170 (e.g., configured to apply feedback from a user and/or machine to a model), and model refinement engine 160 (e.g., configured to tune or re-configure a model). In some disclosed systems, feedback engine 170 may receive input and/or transmit output (e.g., output from a trained, partially trained, or untrained model) to outcome metrics database 180

Outcome metrics database 180 may be configured to store output from one or more models and may also be configured to associate output with one or more models. In some disclosed systems, outcome metrics database 180, or other device (e.g., model refinement engine 160 or feedback engine 170), may be configured to correlate output, detect trends in output data, and/or infer a change to input or model parameters to cause a particular model output or type of model output. In some disclosed systems, model refinement engine 160 may receive output from predictive output generation engine 140 or output validation engine 150. In some disclosed systems, model refinement engine 160 may transmit the received output to ML modelling engine 130 in one or more iterative cycles.

Any or each engine of system 100 may be a module (e.g., a program module), which may be a packaged functional hardware unit designed for use with other components or a part of a program that performs a particular function (e.g., of related functions). Any or each of these modules may be implemented using a computing device. In some disclosed systems, the functionality of system 100 may be split across multiple computing devices to allow for distributed processing of the data, which may improve output speed and reduce computational load on individual devices. In some disclosed systems, system 100 may use load-balancing to maintain stable resource load (e.g., processing load, memory load, or bandwidth load) across multiple computing devices and to reduce the risk of a computing device or connection becoming overloaded. In these or other disclosed examples, the different components may communicate over one or more I/O devices and/or network interfaces.

System 100 can be related to different domains or fields of use. Descriptions of disclosed systems and methods related to specific domains, such as natural language processing or language modeling, is not intended to limit the disclosed systems and methods to those specific domains, and systems and methods consistent with the present disclosure can apply to any domain that utilizes predictive modeling based on available data.

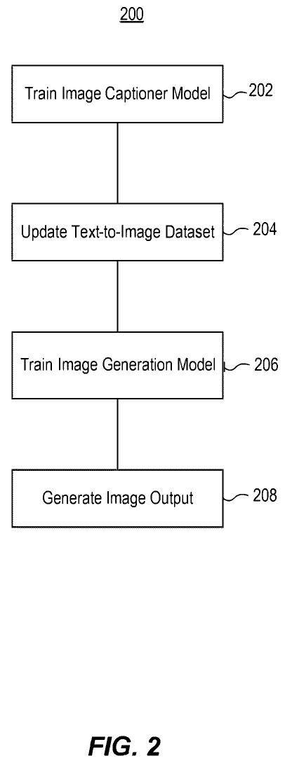

FIG. 2 illustrates a flow diagram of a method 200 for training a text-to-image machine learning model, consistent with systems and methods of the present disclosure. For convenience of description, method 200 may be described herein as being performed by a machine learning system (e.g., such as computing device 902 as referenced in FIG. 9, or the like). However, the disclosed systems and methods are not so limited. For example, method 200 may additionally or alternatively be performed by another system, such as system 100 as referenced in FIG. 1, or by one or more processor(s) 906.

Method 200 may include step 202 of training an image captioner model. A captioner model may be any machine learning model configured to predict or generate text, such as a caption, for a given image. Captioner models may translate an input image to generate textual (e.g., natural language) descriptions. An image captioner model may receive an embedding representation of an image, such as embeddings generated from a shared representational space (e.g., via Contrastive Language-Image Pretraining or CLIP). Captioner models may detect objects, recognize patterns, and/or utilize context in images to understand visual content, and use techniques including natural language processing to generate a caption. Image captioner models may include any model configured for image analysis or text generation, including convolutional neural networks, recurrent neural networks, and transformer models.

In some of the disclosed systems and methods, an image captioner model may include a multimodal model. A multimodal model may be configured to process multiple types or forms of data (e.g., text, images, audio, or video). As an example, a multimodal model may be an end-to-end language model, such as a model that can process different forms or types of inputs and project them to a shared embedding space. As described herein, training a machine learning model may involve manipulating weights or layers of the model. For example, training the captioner model may involve updating and/or refining (e.g., fine-tuning) the model.

In step 202, an image captioner model may receive images and text descriptions corresponding to the images (e.g., captions). For example, the image captioner model may be a language model conditioned on (e.g., guided by) images in a training dataset, and the image captioner model may be augmented with image embeddings. The captions may be of various lengths, such as detailed or descriptive captions, as will be described. Training the image captioner model with the descriptions can include fine-tuning such as reinforcement learning to teach the model to generate higher quality captions.

For example, step 202 may involve receiving feedback on text-image alignment, and thereby the quality of the captions generated by the image captioner model, and the feedback may include parameters based on optimization of an objective function, scores based on alignment of image captions with image embeddings, evaluations from a reward model comparing different captions, or scores from human assessors (e.g., evaluating how well an image generated from a caption follows the caption).

Method 200 may include step 204 of updating a text-to-image dataset. A text-to-image dataset may include image-caption pairs. For example, captions corresponding to the set of images may include details that may explain features of an image or represent the image in a written form. In some examples, image-captions pairs may include a caption which describes prominent aspects, themes, and/or characteristics in the image. Some disclosed systems and methods involve obtaining (e.g., accessing, receiving, sending, transmitting, or acquiring) a text-to-image dataset. For example, image-caption pairs may be stored in a database, stored as part of benchmark training datasets, or available as public datasets. Updating the text-to-image dataset may involve updating images and/or captions in the dataset. For example, captions may be modified or replaced to enhance the dataset. In some disclosed systems and methods, updating a text-to-image dataset may involve applying an image captioner model to images in the dataset. For example, the image captioner model trained in step 202 may analyze images or captions in the dataset and replace or alter captions in the dataset.

Method 200 may include step 206 of training an image generation model (e.g., text-to-image model). The image generation model may refer to any model configured to generate a digital image based on text input, such as encoder-decoder networks, variational autoencoders, transformer models, diffusion models, or Generative Adversarial Networks. The image generation model may be trained with the updated text-to-image dataset. For example, training with the updated text-to-image dataset may include refining or finetuning the image generation model with the updated dataset. In some examples, the image generation model may be trained with the updated dataset, which may include captions modified by the image captioner model. In some examples, the image generation model may be trained on a combination of captions in the updated dataset as well as the ground-truth (e.g., native) captions of the dataset. For example, a blend of updated captions as well as ground-truth captions may be used to reduce overfitting of the image generation model.

Method 200 may include step 208 of generating an image output. The image generation model may be used to generate digital images, including based on a prompt or request. For example, an image generation system may receive a request to generate an image based on a text prompt.

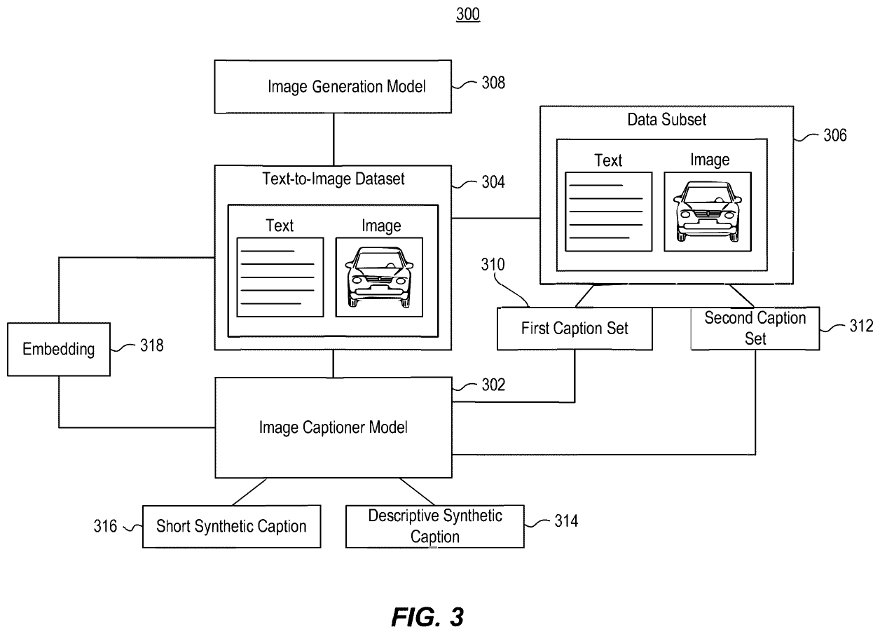

FIG. 3 illustrates a block diagram of a system for recaptioning images, consistent with systems and methods of the present disclosure. Image captioning system 300 may include an image captioner model 302 and a text-to-image dataset 304 for an image generation model 308, as well as data subset 306, which may be a subset of dataset 304. For example, Modeling Engine 130, as referenced in FIG. 1, may include image captioner model 302 and/or image generation model 308. In some examples, data subset 306 may be partitioned into further subsets. In some examples, image generation model 308 may be a text-to-image model.

As described herein, text-to-image dataset 304 may include image-caption pairs such as an image and the corresponding text description of the image available in the dataset. For example, dataset 304 may include images available on the internet and the caption describing the image. Data subset 306 may include a portion of the image-caption pairs from text-to-image dataset 304. Some disclosed systems and methods involve generating an image captioner model configured to generate captions from input images. For example, image captioner model 302 may be configured to generate captions for an image, such as an input of an image from text-to-image dataset 304 or an image from data subset 306. In some disclosed systems and methods, image captioner model 302 may be trained using datasets including image-caption pairs, such as text-to-image dataset 304. For example, image captioner model may be a language model conditioned on (e.g., guided by) images in a training dataset. In some disclosed systems and methods, the image captioner model may be augmented with an image embedding.

An image embedding may refer to a numerical representation of an image, such as a vector. In some examples, the image embedding may be generated through neural networks, such as CNNs, GANs, or transformers. Additionally, or alternatively, image embeddings may be generated and/or obtained from pre-trained models, such as Contrastive Language-Image Pretraining (CLIP). Image embeddings 318 for datasets, such as for text-to-image dataset 304, may be utilized for generating the image captioner model 302. CLIP may provide text and image embeddings mapped to a common representation space. In some disclosed systems and methods, the image embeddings may correspond to a compressed representation space.

For example, pre-training may provide image embeddings which capture and compress the information, including semantics and context, from the image in the training dataset to the vector representation. It will be appreciated that utilizing image embeddings for the image captioner model improves model bandwidth usage and memory usage by providing a compressed representation space for training the image captioner model, thereby reducing the amount of information used for training (e.g., rather than using many pixel values in each image). In some examples, the image captioner model may be generated by maximizing the likelihood function objective

$$L ( t , i ) = {\sum }_{j} log P ( {t}_{j} \vert {t}_{j - k} , … , {t}_{j - 1} ; Θ )$$

or an objective augmented with a CLIP embedding,

$$L ( t , i ) = {\sum }_{j} log P ( {t}_{j} \vert {t}_{j - k} , … , {t}_{j - 1} ; {z}_{j} ; F ( i ) ; Θ )$$

where (t, i) represents a text caption-image pair, respectively, F (i) represents an image embedding function (e.g., a pre-trained CLIP embedding function), and θ represents the parameters of the captioner to be optimized. In some examples, the captioner may be jointly pre-trained with a CLIP and the aforementioned objective.

Some disclosed systems and methods involve performing tuning stages for the image captioner model. Tuning may involve updating and refining the model, such as to align the model with a specific objective. In some disclosed systems and methods, a first tuning stage for the image captioner model includes updating the image captioner model using sets of captions. The sets of captions may correspond to images in a subset of data. For example, tuning may involve training image captioner model 302 with image data from data subset 306 (e.g., the subset of text-to-image dataset 304) and utilizing additional text descriptions for the image data. In some disclosed systems and methods, a first set of captions 310 may correspond to the images in data subset 306. For example, the first set of captions 310 may correspond to a first subset, such as a first portion of the images in data subset 306 (e.g., a subset of data subset 306). It may be desired to train image captioner model 302 to generate short captions, as short-length captions may be similar to ground-truth captions present in various text-to-image datasets. Thus, in some disclosed systems and methods, the first set of captions 310 may be short captions, such as captions that describe the main subject of an image.

For example, the first set of captions 310 used for tuning may be short-length descriptions of the focal point or center of interest of images in the first image subset. Captions in the first set of captions 310 may emphasize the object, figure, or area of the image that draws the most attention. Updating image captioner model 302 may involve training the model on the first set of captions 310 and the corresponding images in the first subset. Thus, image captioner model 302 may learn based on the short, first set of captions 310.

Some disclosed systems and methods involve generating, using the updated image captioner model 302, short synthetic captions 316. For example, the 0 parameter of the likelihood objective may be updated such that the model is tuned to generate short descriptions of the main subject of the image, and these short descriptions may be referred to as short synthetic captions 316. Image captioner model 302 may generate short synthetic captions 316, such as generating a set of short synthetic captions corresponding to images data subset 306 and/or the first subset. It will be appreciated that training on data subsets enhances the training process by reducing demands, as processing entire text-to-image datasets can be memory-intensive, computationally costly, and inefficient.

Some disclosed systems and methods may involve a second tuning stage for the image captioner model 302. In some disclosed systems and methods, a second set of captions 312 may correspond to the images in data subset 306. In some disclosed systems and methods, the second set of captions 312 may correspond to a second subset, such as a second portion of the images in data subset 306. It may be desired to tune image captioner model 302 to generate longer, descriptive captions, as descriptive captions may provide more information about background details, image themes, and relationships presented in the image. Thus, in some disclosed systems and methods, the second set of captions 312 may be descriptive captions, such as captions that describe the main subject of an image as well as image surroundings, background, text present in the image, styles, and/or coloration. For example, the second set of captions 312 used for tuning may be longer-length descriptions of any actions or processes the image may be portraying, and finer details that may be missing in ground-truth captions. Updating image captioner model 302 may involve training the model on the second set of captions 312 and the corresponding images in the second subset. The image captioner model 302 may be configured to learn based on the descriptive, second set of captions 312. It will be appreciated that by learning based on the descriptive captions, the image captioner model 302 may improve in recognizing finer details in images.

Some disclosed systems and methods involve generating, using the updated image captioner model 302, descriptive synthetic captions 314. For example, the 0 parameter of the likelihood objective may be updated such that the model becomes tuned to generate longer, more detailed descriptions of the main subject of the image, and these longer descriptions may be referred to as descriptive synthetic captions 314. Image captioner model 302 may generate descriptive synthetic captions 314, such as generating a set of descriptive synthetic captions corresponding to images in data subset 306 and/or the second subset.

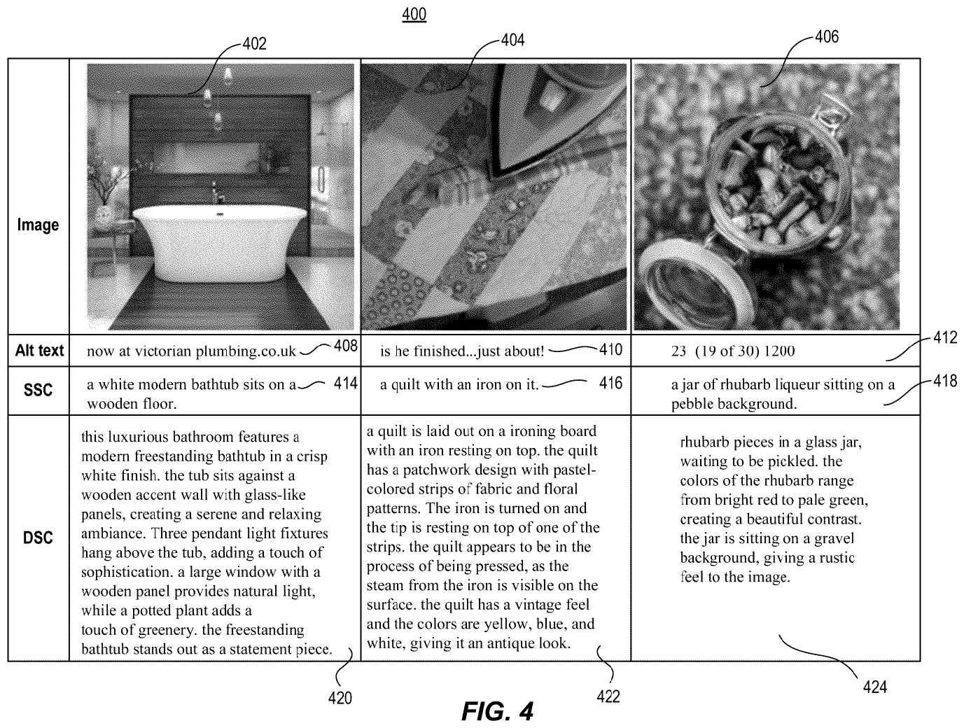

FIG. 4 illustrates a table 400 of exemplary image captions, consistent with systems and methods of the present disclosure. First image 402, second image 404, and third image 406 may be examples of images available in text-to-image datasets, along with corresponding first, second, and third ground-truth captions 408, 410, and 412. It may be that the ground-truth captions (e.g., alt-text) 408, 410, and 412 do not provide information about objects or details within the images and may only be loosely related to the images themselves or may present incorrect information. Thus, as part of text-to-image datasets, such captions may decrease the quality of training and lead to inaccurate image generation for models trained with such datasets.

Table 400 also includes first, second, and third short synthetic captions 414, 416, and 418 corresponding to first image 402, second image 404, and third image 406, respectively. The short synthetic captions 414, 416, and 418 may represent synthetic captions generated by an image captioner model, as described herein. For example, image captioner model 302 as referenced in FIG. 3 may generate the short synthetic captions 414, 416, and 418. It may be that the short synthetic captions 414, 416, and 418 each provide a description of the main subject of the corresponding image, such as a bathtub on a floor for first image 402, a quilt with an iron for second image 404, and a jar for third image 406. Thus, the short synthetic captions may provide more detail and may be better in expressing relevant, accurate information displayed in the images.

Table 400 also includes first, second, and third descriptive synthetic captions 420, 422, and 424 corresponding to first image 402, second image 404, and third image 406, respectively. In some disclosed systems and methods, the length of the descriptive synthetic caption for a given image may be greater than the length of the short synthetic caption for the image. For example, the number of characters, words, or phrases in the descriptive synthetic caption may be greater than that of the short synthetic caption for a given image. The descriptive synthetic captions may be generated by an image captioner model, such as image captioner model 302. The descriptive synthetic captions 420, 422, and 424 may be longer than the short synthetic captions 414, 416, and 418, and the descriptive synthetic captions may describe the main subject of the image (e.g., the “tub” in first image 402) while also describing additional details. For example, descriptive synthetic caption 420 also describes objects in the background, colors present in the image, as well as themes and styles of the image, such as describing the mood portrayed in the image. As such, the descriptive synthetic captions generated by the image captioner model may capture more details and relevant information, thereby improving the quality of captions in the text-to-image dataset and improving the models trained on the text-to-image dataset.

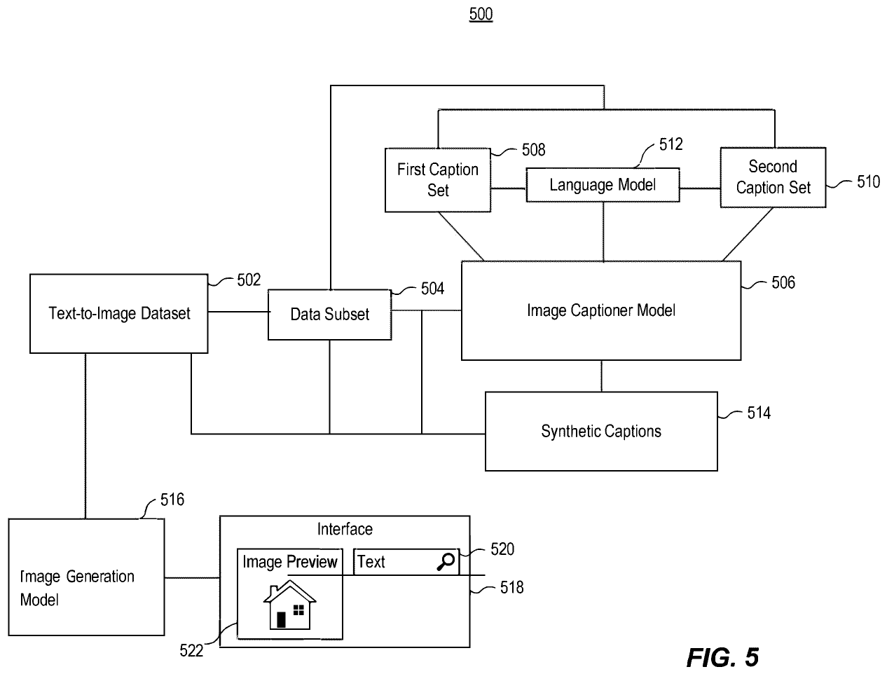

FIG. 5 illustrates a block diagram of a system for generating images with a recaptioned dataset, consistent with systems and methods of the present disclosure. System 500 may include a subset 504 of a text-to-image dataset 502 as well as image captioner model 506. As described herein, image captioner model 506 may be tuned with a first caption set 508. In some examples, the first caption set 508 may be a set of short captions. Additionally, or alternatively, image captioner model 506 may be tuned with second caption set 510. In some examples, the second caption set 510 may be a set of descriptive captions. In some disclosed systems and methods, tuning with second caption set 510 may be performed after tuning with first caption set 508. For example, first caption set 508 may guide image captioner model 506 to generate captions that more accurately describe the main subject of an image in data subset 504, and then second caption set 510 may guide image captioner model 506 to generate captions that accurately describe the background in addition to the main subject of the image. In some disclosed systems and methods, first caption set 508 and/or second caption set 510 may be generated with a machine learning model. For example, language model 512 may receive an input describing the image and generate a short caption and/or a descriptive caption used for tuning of image captioner model 506. Additionally, or alternatively, first caption set 508 and second caption set 510 may include human-written captions, and language model 512 may use the human-written captions to generate new or modified captions to tune image captioner model 506.

The tuned image captioner model 506 may be applied to the images in text-to-image dataset 502 to generate a recaptioned dataset. For example, image captioner model 506 may generate synthetic captions 514, which may include short synthetic captions, descriptive synthetic captions, or both short synthetic captions and descriptive synthetic captions. In some examples, generating a recaptioned dataset may include replacing some or all ground-truth captions in text-to-image dataset 502 with synthetic captions (e.g., from synthetic captions 514). In some examples, image captioner model 506 may be applied to an image in text-to-image dataset 502 by obtaining the image, and the corresponding ground-truth caption for the image may be substituted with a synthetic caption generated by image captioner model 506.

In some disclosed systems and methods, text-to-image datasets may be recaptioned with a blend (e.g., combination) of ground-truth and synthetic captions. For example, applying image captioner model 506 to text-to-image dataset 502 and generating a recaptioned dataset may involve adding synthetic captions to the dataset while keeping the ground-truth captions in the dataset. During data sampling for training of text-to-image model 516, the ground-truth caption or a synthetic caption for a given image in text-to-image dataset 502 may be selected. The ground-truth caption or the synthetic caption may be randomly selected with a predetermined chance of choosing the ground-truth or synthetic caption, such as an exemplary range of 65-99% chance of selecting a synthetic caption. For example, image generation model 516 (e.g., a text-to-image model) may be trained on text-to-image dataset 502 that includes synthetic captions selected using a 95% selection rate (e.g., 5% of the time the ground-truth caption for the image is selected). In another example, the 95% selection rate may refer to 95% of the images in text-to-image dataset 502 having synthetic captions and 5% having ground-truth captions.

Training image generation model 516 may involve updating the model based on the recaptioned text-to-image dataset. As described herein, a recaptioned (e.g., relabeled) text-to-image dataset that includes a blend of synthetic captions and ground-truth captions may improve the training of image generation model 516 by reducing overfitting and enabling regularization of training data. In some disclosed systems and methods, synthetic captions in the recaptioned text-to-image dataset may include short synthetic captions, descriptive synthetic captions, or both short and descriptive synthetic captions. For example, the recaptioned text-to-image dataset used to train image generation model 516 may include 95% synthetic captions and 5% ground-truth captions. It will be appreciated that recaptioning a dataset with an image captioner model improves machine learning model processing resource usage, as image captioner models may be more efficient at captioning for such large datasets (e.g., as compared to large language models), thereby reducing training costs and training time.

As described herein, image generation model 516 may be a machine learning model configured to generate images given text inputs. Image generation model 516 may be trained on image-pair datasets such as text-to-image dataset 502, which may include synthetic captions generated by image captioner model 506. Image generation model 516 may generate images based on an image generation request. In an example, the image generation request may be from another machine learning model or received as a request to generate images for training datasets. In another example, the image generation request may be obtained from an interface, such as interface 518.

A text prompt 520 inputted to interface 518 may be obtained by image generation model 516, which may generate images 522 based on the text prompt. Images 522 may be displayed via interface 518. For example, interface 518 may be an example of a user interface 912, as referenced in FIG. 9 and input/output devices 918 may be used in generation of an image request.

It will be appreciated that image generation models, including text-to-image models, trained on datasets with a blend of synthetic captions (e.g., descriptive synthetic captions) and ground-truth captions may have higher CLIP scores than image generation models trained on datasets with only ground-truth captions, thereby indicating the generated image may be more similar to the given caption. For example, high CLIP scores for an image generated by image generation model 516, such as the CLIP score between image 522 and text prompt 520, may indicate the image 522 is more semantically related to the text input or more accurately depicts the text input.

As described herein, the training of image generation models can be enhanced with training data that includes improved image-caption pairs. Using improved captions provides better training data, thereby leading to better training for image generation models and better images generated by such models.

Some disclosed systems and methods may involve upsampling captions. Upsampling captions can provide improved or enhanced captions. The upsampling of captions may refer to increasing the quality, information, or length of a text description. For example, upsampling a caption may involve making the caption more comprehensive, such as by improving the caption's vocabulary or complexity. In some disclosed systems and methods, a caption in the recaptioned dataset (e.g., text-to-image dataset 502) may be upsampled with a language model, such as language model 512. Large language models can be used to perform upsampling since large language models may be able to explain complex relationships and provide additional details. For example, a large language model may be used to upsample ground-truth captions, short synthetic captions, or descriptive synthetic captions in text-to-image dataset 502. The image generation model 516 may be trained with the dataset to generate images based on upsampled captions. It will be appreciated that by upsampling captions, image generation models may become better adapted to descriptive captions, thereby improving model performance.

An upsampled caption can be provided to an image captioner model for training (e.g., training an image captioner model with upsampled captions). Additionally, or alternatively, an upsampled caption may be utilized to recaption an image-caption pair dataset, such as replacing or updating captions in a dataset used for training of an image generation model with higher quality captions.

Upsampling can also be used on a text prompt corresponding to an image generation request. For example, a language model may upsample text prompt 520 to include more details and intricacies of a desired image generation request, thereby enabling the generated images 522 to be more semantically accurate representations of the input text.

Accordingly, upsampling can improve training datasets, model training, and image generation. For example, utilizing upsampled captions for training datasets can provide better training data for image generation models, thereby improving the training of such models. As a result of improved training, image generations models can produce better images (e.g., images that more accurately follow a prompt). In addition, using upsampled prompt as an input to an image generation model can provide the model with more information (e.g., less ambiguity), resulting in a generated image that better matches the original prompt and is more coherent.

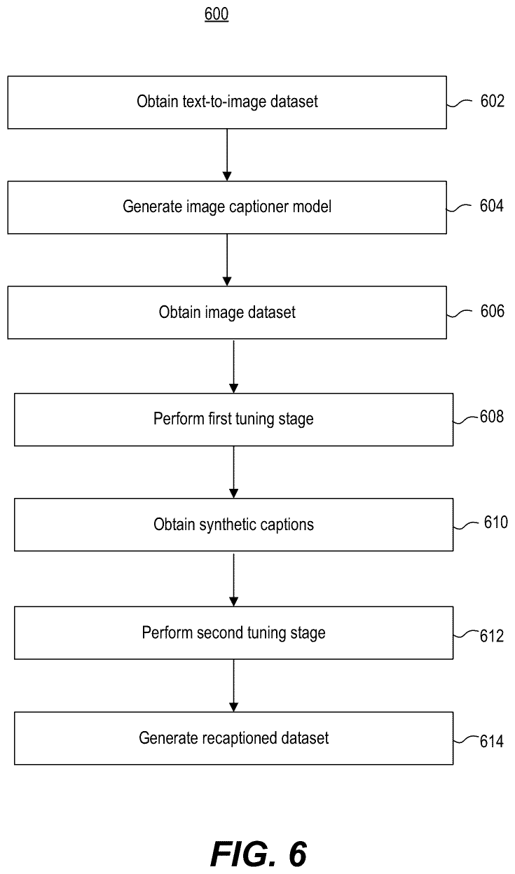

FIG. 6 illustrates an exemplary method 600 for generating image captions for training a machine learning model, consistent with systems and methods of the present disclosure.

Method 600 may include step 602 of obtaining a text-to-image dataset. As described herein, obtaining may involve retrieving, requesting, receiving, acquiring, or accessing information. The text-to-image dataset may include pairs of captions and digital images. In some examples, the text-to-image dataset may be used to train an image generation model (e.g., a text-to-image model).

Method 600 may include step 604 of generating an image captioner model configured to generate captions from input images. The input images may include any digital image input to the image captioner model, such as images from datasets. For example, the image captioner model may be trained using the text-to-image dataset. The image captioner model may be trained on images and/or captions in the text-to-image dataset, which may include ground-truth captions. In some examples, generating the image captioner model may involve augmenting the image captioner model with an image embedding.

Method 600 may include step 606 of obtaining an image dataset. In some disclosed systems and methods, the image dataset may be a subset of the text-to-image dataset. For example, the image subset may include images from the text-to-image dataset, which may be used for training and updating the image captioner model. In some examples, the image dataset may include subsets, such as a first subset and a second subset.

Method 600 may include step 608 of performing a first tuning stage for the image captioner model. The tuning stage may refer to refining or updating the image captioner model to train the image captioner model. In some disclosed systems and methods, the first tuning stage may involve updating the image captioner model using a first set of captions. The first set of captions may correspond to images in the image dataset. The first set of captions may be short captions, such as captions describing a main subject of the image. In some examples, the first set of captions may correspond to at least a first subset of the image dataset. For example, the first set of captions may be captions generated from humans or from a machine learning model for images in the first subset. In some disclosed systems and methods the first set of captions may be short synthetic captions, and the image captioner model may be trained on the short synthetic captions. For example, the first set of synthetic captions may be captions generated for images in the first subset of the image dataset. In some disclosed systems and methods, the first set of synthetic captions may include short synthetic captions, as described herein.

Method 600 may include step 610 of obtaining a set of synthetic captions. The set of synthetic captions may be generated with the tuned image captioner model (e.g., tuned with a first tuning stage in step 608). For example, the set of synthetic captions may be captions generated for images in a subset of the image dataset. In some disclosed systems and methods, the set of synthetic captions may include descriptive synthetic captions, as described herein. In some disclosed systems and methods, captions in the set of descriptive synthetic captions may have a different length than captions corresponding to short synthetic captions. For example, descriptive synthetic captions may be longer (e.g., have a greater length) than a length of the short synthetic captions.

Method 600 may include step 612 of performing a second tuning stage for the updated image captioner model. In some disclosed systems and methods, the second tuning stage may occur after the first tuning stage. The second tuning stage may involve updating the image captioner model using a second set of captions, such as captions corresponding to images in the image dataset. In some disclosed systems and methods, the second tuning stage may use descriptive synthetic captions (e.g., from step 610). For example, the second set of captions may be captions for images in a second subset of the image dataset. In some examples, the second set of captions may correspond to at least a second subset of the image dataset. For example, the first and second subset of images may be inclusive of each other in some disclosed systems and methods, such that the first subset of images may be the same as the second subset of images (e.g., images in the first subset may be the same images as the second subset).

Method 600 may include step 614 of generating a recaptioned dataset. Generating a recaptioned dataset may involve applying the tuned image captioner model to images in the text-to-image dataset. For example, after the first tuning stage (e.g., step 608), the image captioner model may be applied to images in the text-to-image dataset. Additionally, or alternatively, the image captioner model may be applied to images in the text-to-image dataset after a second tuning stage (e.g., step 612). For example, after the second tuning stage, the image captioner model may recaption images in the text-to-image dataset by replacing or modifying the captions. As described herein, recaptioning the dataset may involve changing captions for a certain portion of the dataset, such as recaptioning 95% of the captions in the dataset and keeping 5% of the ground-truth captions. For example, images may be recaptioned with descriptive synthetic captions.

In some examples, applying the image captioner model may involve replacing ground-truth captions in the text-to-image dataset with the short synthetic captions and descriptive synthetic captions corresponding to the first subset and the second subset. Additionally, or alternatively, applying the image captioner model may involve obtaining images in the text-to-image dataset and generating new short and/or descriptive synthetic captions. In some disclosed systems and methods, steps 606, 608, 610, and 612 may be steps for fine-tuning an image captioner model.

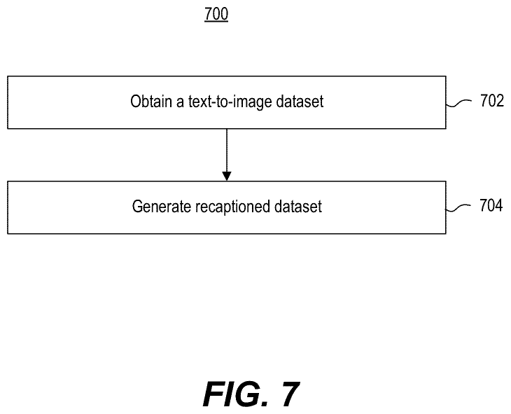

FIG. 7 illustrates an exemplary method 700 for enhancing a training dataset for a machine learning model, consistent with systems and methods of the present disclosure. In some systems and methods, method 700 may be included in process 200, as referenced in FIG. 2.

For example, method 700 may be a part of step 204. Method 700 may include a step 702 of obtaining a text-to-image dataset. A text-to-image dataset may include one or more image-caption pairs, as described herein. Image generation models, such as text-to-image models, may utilize a text-to-image dataset for training. By improving the text-to-image dataset, the image generation model can be trained on improved data, enabling the image generation model to generate better images.

Method 700 may include a step 704 of generating a recaptioned dataset. Generating a recaptioned dataset may involve applying an image captioner model to images in the text-to-image dataset. The image captioner model may be trained with an image dataset. In some systems and methods, the image captioner model may be trained with a first tuning stage and a second tuning stage. For example, the first tuning stage may include updating the image captioner model using a set of short synthetic captions. In some examples, the set of short synthetic captions may correspond to a first subset of the image dataset. Prior to tuning, or during the first tuning stage, the image captioner model can generate a set of short synthetic captions for the image dataset. The second tuning stage may include updating the image captioner model using a set of descriptive synthetic captions. In some examples, the set of descriptive synthetic captions may correspond to a second subset of the image dataset.

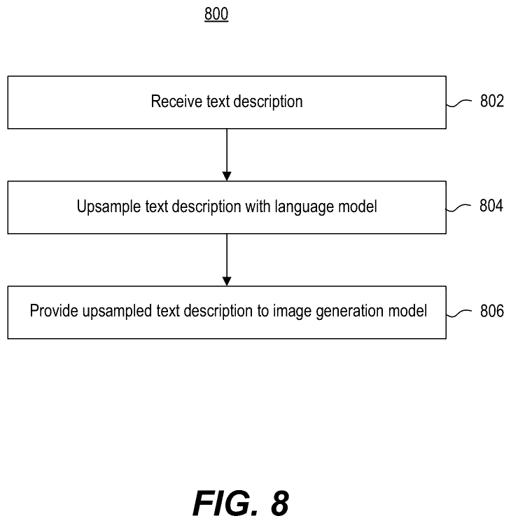

FIG. 8 illustrates an exemplary method 800 for upsampling a text description, consistent with systems and methods of the present disclosure.

Method 800 may include a step 802 of receiving a text description. The text description may correspond to an image. In an example, the text description may be a prompt for an image generation request (e.g., a text input to an image generation model). In another example, the text description may be a caption, such as a caption of an image in a dataset containing image-caption pairs.

Method 800 may include a step 804 of upsampling the text description with a language model. As described herein, upsampling may refer to enhancing the text description, such as increasing the quality, detail, length, or coherence of the text. Step 804 may include upsampling the text description using a language model. For example, the text description may be an input to a language model and the output of the language model may be the upsampled text description. Based on the text description, the language model may improve the text description, such as by expanding on the text description (e.g., providing more detail), rephrasing or restructuring the text, improving the coherence of the text (e.g., generate a more logical or understandable output), adding contextual information, or adjusting the prompt for relevance, as non-limiting examples.

Method 800 may include a step 806 of providing the upsampled text description. In some systems and methods, the upsampled text description may be provided to an image generation model. For example, the upsampled text description may be provided to such a model as part of an image generation request (e.g., a prompt). It will be appreciated that, as the upsampled image can be of higher quality or contain more detail, the image generation model can have better data to understand the prompt, resulting in the model generating an improved image as compared to a lower-quality prompt. The image generation model may be trained with an image-caption pair dataset, as described herein. The image-caption pair dataset may include enhanced captions, such as captions generated by an image captioner model.

An exemplary operating environment for implementing various aspects of this disclosure is illustrated in FIG. 9. As illustrated in FIG. 9, an exemplary operating environment 900 may include a computing device 902 (e.g., a general-purpose computing device) in the form of a computer. Components of the computing device 902 may include, but are not limited to, various hardware components, such as one or more processors 906, data storage 908, a system memory 904, other hardware 910, and a system bus (not shown) that couples (e.g., communicably couples, physically couples, and/or electrically couples) various system components such that the components may transmit data to and from one another.

The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 9, an operating environment 900 for an exemplary system includes at least one computing device 902. The computing device 902 may be a uniprocessor or multiprocessor computing device. An operating environment 900 may include one or more computing devices (e.g., multiple computing devices 902) in a given computer system, which may be clustered, part of a local area network (LAN), part of a wide area network (WAN), client-server networked, peer-to-peer networked within a cloud, or otherwise communicably linked. A computer system may include an individual machine or a group of cooperating machines. A given computing device 902 may be configured for end-users, e.g., with applications, for administrators, as a server, as a distributed processing node, as a special-purpose processing device, or otherwise configured to train machine learning models and/or use machine learning models.

One or more users may interact with the computer system comprising one or more computing devices 902 by using a display, keyboard, mouse, microphone, touchpad, camera, sensor (e.g., touch sensor) and other input/output devices 918, via typed text, touch, voice, movement, computer vision, gestures, and/or other forms of input/output. An input/output device 918 may be removable (e.g., a connectable mouse or keyboard) or may be an integral part of the computing device 902 (e.g., a touchscreen, a built-in microphone).

A user interface 912 may support interaction between disclosed systems and one or more users. A user interface 912 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other NUI may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, game port or a universal serial bus (USB).

A monitor or other type of display device is also connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers and printer, which may be connected through an output peripheral interface or the like.

One or more application programming interface (API) calls may be made between input/output devices 918 and computing device 902, based on input received from at user interface 912 and/or from network(s) 916. As used throughout, “based on” may refer to being established or founded upon a use of, changed by, influenced by, caused by, or otherwise derived from. In some examples, an API call may be configured for a particular API, and may be interpreted and/or translated to an API call configured for a different API. As used herein, an API may refer to a defined (e.g., according to an API specification) interface or connection between computers or between computer programs.

System administrators, network administrators, software developers, engineers, and end-users are each a particular type of user. Automated agents, scripts, playback software, and the like acting on behalf of one or more people may also constitute a user. Storage devices and/or networking devices may be considered peripheral equipment in some examples and part of a system comprising one or more computing devices 902 in other examples, depending on their detachability from the processor(s) 906. Other computerized devices and/or systems not shown in FIG. 9 may interact in technological ways with computing device 902 or with another system using one or more connections to a network 916 via a network interface 914, which may include network interface equipment, such as a physical network interface controller (NIC) or a virtual network interface (VIF).

Computing device 902 includes at least one logical processor 906. The at least one logical processor 906 may include circuitry and transistors configured to execute instructions from memory (e.g., memory 904). For example, the at least one logical processor 906 may include one or more central processing units (CPUs), arithmetic logic units (ALUs), Floating Point Units (FPUs), and/or Graphics Processing Units (GPUs). The computing device 902, like other suitable devices, also includes one or more computer-readable storage media, which may include, but are not limited to, memory 904 and data storage 908.

In some examples, memory 904 and data storage 908 may be part a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 920 such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 902, making its content accessible for interaction with and use by processor(s) 906. The removable configured medium 920 is an example of a computer-readable storage medium. Some other examples of computer-readable storage media include built-in random access memory (RAM), read-only memory (ROM), hard disks, and other memory storage devices which are not readily removable by users (e.g., memory 904).

The configured medium 920 may be configured with instructions (e.g., binary instructions) that are executable by a processor 906; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 920 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although disclosed systems, methods, and computer-readable media may be described as being implemented as software instructions executed by one or more processors in a computing device (e.g., general-purpose computer, server, or cluster), such description is not meant to exhaust all possible examples. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an system may include other hardware logic components 910 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an system may be grouped into interacting functional modules based on their inputs, outputs, and/or their technical effects, for example.

In addition to processor(s) 906, memory 904, data storage 908, and screens/displays, an operating environment may also include other hardware 910, such as batteries, buses, power supplies, wired and wireless network interface cards, for instance. The nouns “screen” and “display” are used interchangeably herein. A display may include one or more touch screens, screens responsive to input from a pen or tablet, or screens which operate solely for output. In some disclosed systems, other input/output devices 918 such as human user input/output devices (screen, keyboard, mouse, tablet, microphone, speaker, motion sensor, etc.) will be present in operable communication with one or more processors 906 and memory.

In some disclosed systems, the system includes multiple computing devices 902 connected by network(s) 916. Networking interface equipment can provide access to network(s) 916, using components (which may be part of a network interface 914) such as a packet-switched network interface card, a wireless transceiver, or a telephone network interface, for example, which may be present in a given computer system. However, a system may also communicate technical data and/or technical instructions through direct memory access, removable non-volatile media, or other information storage-retrieval and/or transmission approaches.

The computing device 902 may operate in a networked or cloud-computing environment using logical connections to one or more remote devices (e.g., using network(s) 916), such as a remote computer (e.g., another computing device 902). The remote computer may include one or more of a personal computer, a server, a router, a network PC, or a peer device or other common network node, and may include any or all of the elements described above relative to the computer. The logical connections may include one or more LANs, WANS, and/or the Internet.

When used in a networked or cloud-computing environment, computing device 902 may be connected to a public or private network through a network interface or adapter. In some examples, a modem or other communication connection device may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

Computing device 902 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer.

Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of the any of the above may also be included within the scope of computer-readable media. Computer-readable media may be included as a computer program product, such as software (e.g., including program modules) stored on non-transitory computer-readable storage media.

The data storage 908 or system memory includes computer storage media in the form of volatile and/or nonvolatile memory such as ROM and RAM. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 908 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Disclosed examples include systems, methods, and computer readable media for the generation of text and/or code embeddings. For example, in some examples, and as illustrated in FIG. 9, an operating environment 900 may include at least one computing device 902, the at least one computing device 902 including at least one processor 906, at least one memory 904, at least one data storage 908, and/or any other component discussed above with respect to FIG. 1.

This disclosure may be described in the general context of customized hardware capable of executing customized preloaded instructions, such as computer-executable instructions for performing program modules. Program modules may include one or more of routines, programs, objects, variables, commands, scripts, functions, applications, components, data structures, and so forth, which may perform particular tasks or implement particular abstract data types. The disclosed systems, methods, and computer-readable media may also be practiced in distributed computing environments where tasks are performed by remote processing devices that are linked through a communications network. In a distributed computing environment, program modules may be located in local and/or remote computer storage media including memory storage devices.

Example systems and methods are described herein with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed systems, methods, and computer-readable media may also be practiced in distributed computing environments where tasks are performed by remote processing devices that are linked through a communications network. In a distributed computing environment, program modules may be located in local and/or remote computer storage media including memory storage devices.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, such as the disclosed systems and methods, may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowcharts and block diagrams in the figures illustrate examples of the architecture, functionality, and operation of possible implementations of systems, methods, and computer program products. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order, or performed with steps omitted, while implementing the same method.

What is claimed is:

1. A method for enhancing a training dataset for a machine learning model, the method comprising:
obtaining a text-to-image dataset comprising one or more digital image-caption pairs; and
generating a recaptioned dataset by applying an image captioner model to images in the text-to-image dataset, the image captioner model trained with an image dataset, a first tuning stage, and a second tuning stage.

2. The method of claim 1, wherein generating the recaptioned dataset comprises updating one or more captions in the text-to-image dataset using the image captioner model.

3. The method of claim 1, wherein the first tuning stage comprises:
obtaining a first set of captions corresponding to at least a first subset of the image dataset; and
updating, based on the first set of captions, the image captioner model.

4. The method of claim 3, wherein:
the image captioner model is configured to generate short synthetic captions, and
the first set of captions describe a main subject of an image in the image dataset.

5. The method of claim 3, wherein the second tuning stage comprises:
obtaining a second set of captions corresponding to at least a second subset of the image dataset, wherein captions of the second set of captions have a length that is longer than captions of the first set of captions; and
updating, based on the second set of captions, the image captioner model.

6. The method of claim 5, wherein:
the image dataset is a subset of the text-to-image dataset; and
the first subset and the second subset are inclusive of each other.

7. The method of claim 5, wherein:
the image captioner model is configured to generate descriptive synthetic captions, and
the second set of captions describe the main subject plus at least one of surroundings,
background, image text, style, or coloration of an image in the image dataset.

8. The method of claim 5, wherein at least one of the first set of captions or the second set of captions are generated with a machine learning model.

9. The method of claim 1, further comprising augmenting the image captioner model with an image embedding, the image embedding corresponding to a compressed representation space.

10. The method of claim 1, further comprising training an image generation model with the recaptioned dataset.

11. The method of claim 1, further comprising upsampling a caption in the recaptioned dataset using a large language model.

12. A system comprising:
at least one memory storing instructions;
at least one processor configured to execute the instructions to perform operations, the operations comprising:
generating an image captioner model configured to generate captions from input images, the image captioner model trained using a text-to-image dataset, wherein the text-to-image dataset comprises one or more digital image-caption pairs;
performing a first tuning stage for the image captioner model, the first tuning stage comprising:
training the image captioner model using a first set of captions corresponding to at least a first subset of an image dataset;
obtaining a set of synthetic captions;
after the first tuning stage, performing a second tuning stage for the trained image captioner model, the second tuning stage comprising:
training the image captioner using the set of synthetic captions; and
generating a captioned dataset by applying the tuned image captioner model to images in a dataset.

13. The system of claim 12, wherein the image dataset is a subset of the text-to-image dataset.

14. The system of claim 12, wherein the first set of captions comprises short captions, the short captions describing a main subject of an image in the image dataset.

15. The system of claim 12, further comprising training a text-to-image machine learning model with the captioned dataset.

16. A system comprising:
at least one memory storing instructions;
at least one processor configured to execute the instructions to perform operations, the operations comprising:
receiving a text description corresponding to an image;
upsampling the text description with a language model; and
providing the upsampled text description to an image generation model, the image generation model trained with a dataset comprising image-caption pairs, wherein at least a portion of captions are generated with an image captioner model.

17. The system of claim 16, wherein the image captioner model is trained with a first tuning stage and a second tuning stage.

18. The system of claim 16, wherein the image captioner model is configured to generate short synthetic captions.

19. The system of claim 16, wherein the image captioner model is configured to generate descriptive synthetic captions.

20. The system of claim 16, wherein the upsampling increases the length of the text description.
